(19) United States
(12) Patent Application Publication
(10) Pub. No.: US 2004/0006147 A1
(43) Pub. Date: Jan. 8, 2004

(54) Physical properties improvement additive for flexible polyurethane foam

(76) Inventor: Dennis R. Spicher, Atlanta, GA (US)

Correspondence Address: Dickstein Shapiro Morin & Oshinsky, 2101 L Street NW, Washington, DC, 20037-1526, US

(21) Appl. No.: 10/276,551

(22) PCT Filed: Feb. 22, 2002
(86) PCT No.: PCT/US02/05076

(51) Int. Cl. C08J 9/00; C08G 18/00

(52) U.S. Cl. 521/50; 521/155

(57) ABSTRACT

An exotherm reducing additive including a tetrahalogenated ionic compound and an exotherm reducing additive composition for organic polymer compositions including an exotherm reducing-effective amount of the tetrahalogenated ionic compound, a solvent for the tetrahalogenated ionic compound, and a diluent compatible with the tetrahalogenated ionic compound, the solvent and the organic polymer composition, The tetrahalogenated ionic compound preferably is a tetrahalogenated borate, and more specifically lithium or sodium tetrafluoroborate. Organic polymer compositions containing the additive also are provided, as are methods incorporating the additive into the polymer compositions.

This application claims the benefit of U.S. Provisional Application Serial No. 60/270,937 filed Feb. 23, 2001.

### BACKGROUND OF THE INVENTION

1. Field of the Invention

The present invention relates to physical properties improvement additives for chemical compositions, and, more particularly, to tetrahalogenated ionic compounds, and additives including tetrahalogenated ionic compounds for organic polymer compositions such as flexible polyurethane foams, both polyether and polyester.

2. Description of the Related Art

a. Commercial Applications of Organic Polymer Compositions

The use of flexible polyurethane foam for diverse applications has grown dramatically in the last thirty years. This can be attributed to many factors: the optimized and economical production methods for producing large, continuous blocks of this material; its cost/performance benefits versus many other plastics across a broad cross-section of industrial and consumer applications; its ease of fabrication into shaped pieces, sheets, and blocks; its relatively low toxicity; and the wide variation possible in the physical properties of the material using production techniques and a wide variety of chemical additives. Flexible polyurethane foam, in variations of density and firmness, is used in many markets: bedding, seating and cushioning, in both consumer goods and automotive applications; packaging; carpet underlayment; medical products; sound-deadening; insulation; and others.

A variety of production techniques are employed in the production of flexible polyurethane foam, the most widely used method being the dispensing of a foaming chemical mass on a moving conveyor (via a trough or by direct laydown), followed by the expansion and polymerization of the foaming chemicals against a continuously moving bottom conveyor and sidewalls to create a long block of cellular polyurethane. The process is a combination of chemical and mechanical variables which must be carefully controlled to produce acceptable product of uniform physical properties while minimizing chemical emissions and trim waste. Variations of this production scheme have been explored in the goal of increasing production efficiencies and great strides, both in chemical formulation and mechanical modifications, have been made to achieve the current state of the art.

A persistent problem, however, in continuous block flexible polyurethane foam production is the consequence of the high temperatures, or exotherm, within the foaming mass during production which results from the reaction between the isocyanate employed (usually TDI, MDI or an aliphatic isocyanate) and the water present in the formulation. The isocyanate-water reaction is necessary to generate hard-segment urea domains within the foam which contribute to firmness and other physical properties, and also to generate carbon dioxide gas which aids in the cell-formation process, but because of the exothermic nature of this reaction the amount of water which can be incorporated in a given formulation is limited. In the extreme, an excess of water can result in temperatures within the self-insulating foam block of greater than 400° F. and can be responsible for auto-ignition of the block. At water levels necessary to produce foams of low density (16 kg/m3 or less), the exotherm generated can cause a variety of physical property disturbances within the block, which include discoloration or “scorch”, variations in density and firmness in the block, and decreased performance with respect to tensile, tear and elongation properties. All of these problems result in a final product of less than optimal performance for the end-user, and represent a cost to the polyurethane processor due to unusable product, returned goods or loss of market opportunities vis-Fà-vis other plastic materials.

b. Prior Art for Exotherm-related Physical Property Improvement

A review of the literature produces little in the way of prior art additives for physical property improvement via exotherm reduction. For many years, the solutions to exotherm-related problems for polyurethane foam producers fell into one of five areas: (1) antioxidant additives, (2) auxiliary blowing agents, (3) filler materials, (4) mechanical processes for quick cooling, and (5) specialized fabrication techniques.

Antioxidant additives are typically compounded into the polyol component by the manufacturer of the polyol itself. A variety of chemical antioxidants have been employed, the most effective of which is butylated hydroxytoluene (BHT), along with a wide range of hindered phenolic compounds, organophosphites and complex conjugated organic compounds. Such additives are generally incorporated in the polyol component at parts-per-million levels. Recent industry concerns, however have implicated the presence of BHT in causing discoloration of carpeting and materials which are placed in contact with the BHT-containing flexible foam, with the result that many polyol producers have been forced to eliminate this very effective antioxidant from their products. Replacement of BHT with one or a combination of less effective antioxidant alternatives has led to an increase in scorch-related complaints in recent months.

Auxiliary blowing agents have long been used to cool foam block exotherms and reduce scorch and physical property effects. Because, however, in most causes the auxiliary blowing agent does not react permanently into the polymer matrix and is liberated to the atmosphere, the industry has progressed through a series of blowing agents such as chlorofluorocarbon 11, methylene chloride, 1,1,1-trichloroethane, acetone and carbon dioxide, all of which introduce new processing problems along with concerns over their environmental impact. These blowing agents produce a varying level of cooling effect in the foam block as they transition from the liquid to vapor state, based in large part on their latent heat of vaporization. A side benefit (or disadvantage) to these blowing agents is their tendency to decrease the foam density and soften the foam product.

Filler materials have long been used in heat-sink type applications to cool foam blocks. Mineral fillers such as finely-ground calcium carbonate and barium sulfate, synthetic fillers such as granular melamine and organic polymer fillers (such as styrene-acrylonitrile in graft and polymer polyols) can serve to reduce block exotherm to a degree and thereby reduce scorch and heat-related physical property degradation. The addition of any of these fillers, however, also raises foam density and hardness, which can be desirable or undesirable depending on the endproduct application.

Most recently developed are physical processes for rapid cooling of the foam block by means of mechanically aspirated air (or chemically treated air). These processes require a large investment in air-moving equipment such as fans, blowers, and ducting and also require a physical arrangement for the intimate contact of the foam block with a suction plate of some type. Quick-cooling (or post-cooling as it is also known) is very effective in reducing exotherm-related physical property gradients within the foam block and also reducing discoloration. The disadvantages to these processes are their large energy and capital investment requirements, the cycle time needed for post-cooling each foam block, and the frequent need for post-treatment of the aspirated air by carbon filter bed to remove organics prior to discharge to the atmosphere. Also, because these post-cooling processes are applied to the foam block several minutes after production (albeit before maximum exotherm is reached), they do not address exotherm-related physical problems which can arise during the first 5-7 minutes of block production.

Many producers resort to specialized fabrication techniques to minimize exotherm damage, such as trimming off the block top- and side-skin, vertically cutting short blocks to allow faster cooling and “slabbing”, the practice of cutting the block into thinner horizontal slabs immediately following production, all of which allow for more rapid exotherm dissipation. Such techniques can be effective in producing more uniform physical properties in the foam material, but in many cases at the expense of other production efficiency considerations.

### SUMMARY OF THE INVENTION

The present invention overcomes many of the disadvantages of the prior art, such as those noted above, by providing tetrahalogenated ionic salts as exotherm-reducing and physical property improvement additives. The exotherm-reducing tetrahalogenated ionic compounds used according to the present invention can include any of the halogens, i.e. fluorine, chlorine, bromine, iodine or astatine. The tetrahalogenated ionic salts having exotherm-reducing activity according to the present invention broadly include ionic salts of tetrahalogenated compounds. The most preferred of these include tetrahalogenated anionic compounds of the group IIIA elements boron, aluminum, gallium, indium, and thallium.

Tetrahalogenated ionic salts of the present invention can be formed, for example, with any of the salt-forming cations, such as ammonium, or any of the salt-forming alkali metals, such as lithium, sodium, potassium, rubidium and cesium.

In addition, according to the present invention, the tetrahalogenated ionic salt can be added directly, or is included in an additive composition for use in chemical compositions. According to the present invention, the exotherm-reducing additive for chemical compositions includes a tetrahalogenated ionic compound, a solvent for the tetrahalogenated ionic compound, and a diluent compatible with the tetrahalogenated ionic compound, the solvent, and the chemical composition.

Advantageously, the present invention provides an exotherm-reducing polymer composition and a method of making the composition in which an organic polymer composition is rendered lower in exotherm by including the tetrahalogenated ionic compound as an exotherm-reducing additive. In a preferred embodiment, the organic polymer composition is polyurethane foam.

The present invention provides exotherm-reduction and physical property improvements not heretofore available to the flexible polyurethane foam producer. The invention enables production of foam blocks with more uniform physical properties than would otherwise by permitted by the prior-art methods described above. The present invention can be used in combination with any or a combination of the prior-art methods described above to yield superior results than these methods used alone. Additionally, while achieving exotherm-reducing behavior, use of the present invention results in no deleterious interactions or side-effects with commonly used polyurethane intermediates.

### BRIEF DESCRIPTION OF THE DRAWINGS

FIG. 1 is a graph showing a block exotherm diagram in degrees Fahrenheit over time and comparing the effects of the exotherm reducing additive of the present invention to a control.

FIG. 2 is a diagrammatic cross-section of a commercially produced flexible polyether polyurethane block showing the density values resulting from use of an exotherm reducing additive according to the present invention.

FIG. 3 is a diagrammatic cross-section of a commercially produced flexible polyether polyurethane block showing the Indentation Force Deflection (IFD) values resulting from use of an exotherm reducing additive according to the present invention.

### DETAILED DESCRIPTION OF THE PREFERRED EMBODIMENTS

I. Exotherm Reducing Compound

The active exotherm reducing compounds according to the present invention are tetrahalogenated ionic compounds. The exotherm reducing compounds of the present invention can be described generally as the tetrahalogens of the Group IIIA elements, and salts thereof. The exotherm reducing tetrahalogenated ionic compounds of the present invention include particularly the ammonium, lithium, sodium, potassium, rubidium, and cesium salts of tetrahalogenated boron, aluminum, gallium, indium, and thalium compounds, although salts of other cations are considered to be within the scope of the present invention. Other tetrahalogenated compounds are considered to be within the scope of the present invention, particularly those of elements from the chemically similar neighbors of Group IIIA.

The exotherm reducing compound can be used in neat form, according to the present invention. For example, the exotherm reducing compound can be added directly as a powder dispersed in the polyol component. The range of the active ingredient according the present invention which is needed to render, for example, an organic polymer composition exotherm reducing, is dependent upon polymer density. The higher the density of the polymer composition, the less exotherm reducing additive is required. Effective amounts can be determined by routine experimentation by those skilled in the art.

The choice of the particular tetrahalogenated ionic compound to be used depends in part on commercial availability. Various tetrahalogenated phosphates, for example, in combination or alone, can be used as the active ingredient, lithium or sodium tetrafluoroborate being most preferred, though others are commercially available.

The criteria for choosing the most preferred active ingredient of the present invention are (a) solubility, (b) decomposition temperature, (c) fluorine content, and (d) cost/performance. The sodium form at present is more commercially available and economical than the lithium analog, and exhibits an advantageous combination of better water and solvent solubility, higher fluorine content and acceptable decomposition temperature with respect to the other analogs (see Table 1; reference “The Chemistry of Boron and its Compounds”, Earl L. Muetterties, New York, Wiley, 1967, pp. 335-337.)

TABLE 1
PROPERTIES OF VARIOUS
TETRAHALOGENATED BORATES

| | Melting | % F | Solubility in Water |
|---|---|---|---|
| | Point, | (theo- | g./100 g. |
| | ° C. | retical) | water/° C. |
| LiBF₄ | Decomposes | 81.1% | Very soluble |
| NaBF₄ | 384 (decomposes) | 69.2% | 52% by wt. |
| KBF₄ | 530 (decomposes) | 60.4% | 0.448/20 |
| RbBF₄ | 590 | 44.1% | 0.55/20 |
| CsBF₄ | 550 | 34.6% | 0.92/20 |
| NH₄BF₄ | 230 (sublimes) | 73.9% | 20.3/23 |

II. Exotherm Reducing Additive Composition

The preferred exotherm reducing additive composition of the present invention includes an exotherm reducing amount of one of the tetrahalogenated ionic compounds, upon addition of the additive to the composition to be rendered exotherm reducing. In addition, the additive composition can include one or more co-solvents, and diluent.

A. Active Ingredient

The active exotherm reducing ingredient for the additive composition according to the present invention is the tetrahalogenated ionic compound described above. The exotherm reducing ionic compound of the present invention can be included in the additive composition in varying amounts. In a typical application, the ionic compound is included in an amount ranging approximately from 0.5-15% by weight of the additive composition. In a most preferred embodiment, the ionic compound of the present invention is included in the 2.25-10% range by weight of the exotherm reducing additive composition of the present invention. The above percentages are illustrative, and may be varied depending on various factors, including the chemical formulation or type of polymer to be treated with the exotherm reducing additive.

B. Solvent

In formulating the exotherm reducing additive composition of the present invention, a co-solvent can be included to solubilize the active ingredient. The solvent employed can be any compound that will solubilize the active ingredient, examples of which are water, N-methylpyrrolidone, and low molecular weight polyethylene glycol.

The co-solvent, preferably N-methylpyrrolidone, is included in the range of approximately 1.1-22% by weight of the additive composition. The co-solvent is most preferably used in the 4.5-15% range. Again, these percentages can be varied outside these ranges depending upon the requirements of the particular application.

C. Diluent

A diluent can be included in the exotherm reducing additive of the present invention to make the active/co-solvent system compatible with the composition to be treated. The diluent can be any compound that is compatible with the active/solvent system and the composition to be rendered exotherm reducing.

When preparing PU foams, for example, a urethane polyol is a preferred diluent. Such a polyol is completely compatible with generally-used foam formulations, and is readily available.

Other diluents can be used, including, but not limited to polypropylene glycols and triols, including dipropylene glycol; poly(oxy)propylene glycols and triols, including but not limited to glycerine and/or hexanetriol-initiated triols; and plasticizers.

III. Foam Production

Flexible PU foam is produced from a mixture of chemical ingredients (mostly in liquid form; some are slurried or dispersed solid in liquid) which are brought together in a mixing head and then dispensed on a moving conveyor lined with plastic film or kraft paper.

The reaction of the polyol and isocyanate produce the solid portion of the polymer, while at the same time a competing reaction between water and isocyanate generates carbon dioxide gas, this gas giving the reaction mixture a foaming, or “cellular” quality (as opposed to solid elastomer).

The polyol-isocyanate reaction is controlled (catalyzed) by the addition of a small amount of tin-based catalyst (usually stannous octoate or dibutyl tin dilaurate), while the water-isocyanate reaction is catalyzed by a small amount of a tertiary amine-type additive. A silicone surfactant is included which stabilizes the rising foaming mass until it “cures” or solidifies into a self-supporting block.

The chemical components are delivered via pump and metering controls to the mixing head in separate streams, or in some cases certain of the components will be pre-combined (“batched”) and then delivered to the mixing head. The exotherm reducing additive is added at this stage either as a separate component, or prebatched with one of the other components.

IV. Reduced Exotherm Foam Production and Formulations

### EXAMPLE

A typical 1.3 pcf, 35 Indentation Force Deflection (IFD) formulation using the present invention (commercially available from the assignee of the present invention as CELLTECH® ERA Additive) is as follows:

| | Parts per Hundred |
|---|---|
| Component | (based on polyol) |
| ALCUPOL* F-5511 Polyol | 100 |
| (55 hydroxyl, EO/PO polyether triol) | |
| Water | 4.90 |
| CELLCAT* 215 Amine Catalyst | 0.10 |
| Union Carbide* L-620 Silicone Surfactant | 0.85 |
| CELLCAT* C-2 Tin Catalyst | 0.23 |
| CELLTECH* EPA Additive | 5.0 |
| Toluene Diisocyanate 80/20 (105 index) | 58.65 |

Concentrations of each ingredient are given based on “parts per hundred” of the polyol. The formulation is always based on “100 parts polyol”. The formulations are generally based on “100 parts polyol”. To determine the stoichiometric amount of isocyanate to be used (or in this case, an 5% excess of TDI, denoted as “105 index”), the total equivalent weight of hydroxyl functionality in the mixture is calculated (polyol, water and any other hydroxyl-containing components, since the isocyanate reacts with hydroxyl-containing ingredients) and an equivalent weight of TDI used. Note that the present invention, because it is diluted with a hydroxyl-containing compound, must be included in the stoichiometric isocyanate calculations.

Use levels of exotherm-reducing additive based on weight percent can easily be calculated by summing the total weight of all the components and expressing the additive level in percent form. For example, the exotherm-reducing additive is used in Example 1 above at 5÷169.73=2.94% by weight.

V. Efficacy

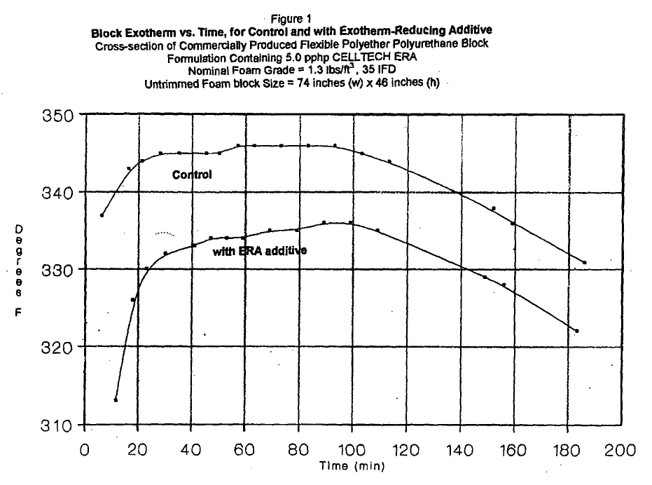

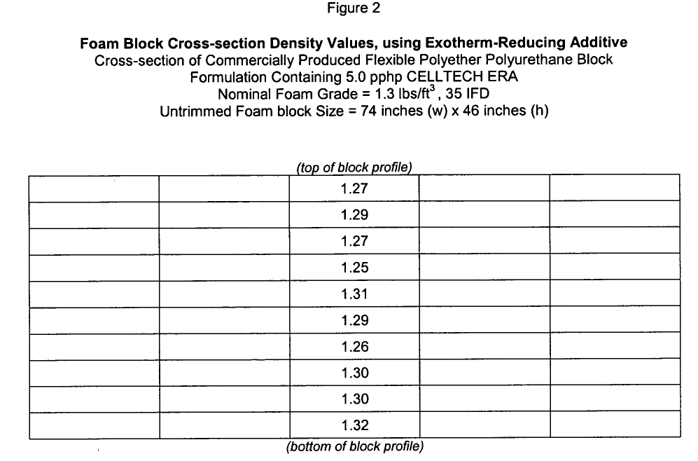

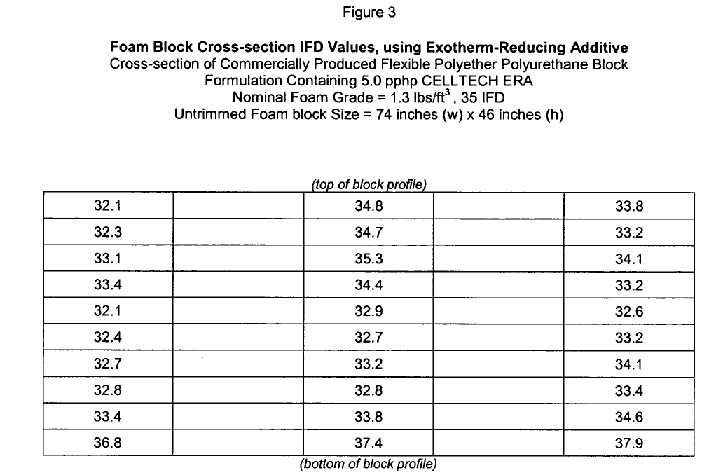

Test results demonstrate that the exotherm-reducing ionic compounds and the exotherm-reducing additive of the present invention advantageously provide a dramatic reduction in foam block exotherm, and a concomitant reduction in physical property (density and firmness) gradients. (see FIG. 1 “Block Exotherm vs. Time, for Control and with Additive”; FIG. 2 “Foam Block Cross-section Density Values, using Additive”; and FIG. 3 “Foam Block Cross-section IFD Values, using Additive”).

Although the present invention has been described in relation to particular embodiments thereof, many other variations and modifications and other uses will become apparent to those skilled in the art. Therefore, the present invention is to be limited not by the specific disclosure herein, but only by the appended claims.

What is claimed is:

1. An organic polymer composition comprising:
an organic polymer; and
an exotherm reducing amount of a tetrahalogenated ionic compound of the form AMX₄, where A is inorganic, and is a salt-forming cation or a salt-forming alkali metal; M is an element, or a compound containing an element, the element being selected from Group IIIA of the periodic table; and X is a halogen.

2. The organic polymer composition of claim 1, further comprising a solvent for the tetrahalogenated ionic compound.

3. The organic polymer composition of claim 2, further comprising a diluent compatible with the tetrahalogenated ionic compound, the solvent and the organic polymer.

4. The organic polymer composition of claim 1, wherein the organic polymer is in the form of a foam.

5. The organic polymer composition of claim 1, wherein the polymer is polyurethane.

6. The organic polymer composition of claim 5, wherein the polyurethane is foamed or foamable.

7. An organic polymer composition comprising:
an organic polymer; and
about 0.5% to about 15% by weight of a tetrahalogenated ionic compound of the form AMX₄, where A is a salt-forming cation or a salt-forming alkali metal; M is an element, or a compound containing an element, the element being selected from Group IIIA of the periodic table; and X is a halogen.

8. The organic polymer composition of claim 7, further comprising a solvent for the tetrahalogenated ionic compound.

9. The organic polymer composition of claim 8, further comprising a diluent that is compatible with the organic polymer, the tetrahalogenated ionic compound, and the solvent.

10. The organic polymer composition of claim 7, wherein the organic polymer is polyurethane.

11. The organic polymer composition of claim 10, wherein the polyurethane is foamed or foamable.

12. An organic polymer composition comprising:
a polyurethane; and
an exotherm reducing amount of a tetraahalogenated ionic compound of the form AMX₄, where A is inorganic, and is a salt-forming cation or a salt-forming alkali metal; M is an element, or a compound containing an element, selected from Group IIIA of the periodic table.

13. The organic polymer composition of claim 12, further comprising a solvent for the tetrahalogenated ionic compound, and a diluent compatible with the polyurethane, the tetrahalogenated ionic compound, and the solvent.

14. The organic polymer composition of claim 12, wherein the polyurethane is in the form of a foam.

15. A method of imparting exotherm reduced properties to a foamed polyurethane composition that comprises the steps of:
adding an exotherm reducing amount of an inorganic tetrahalogenated ionic compound to a polyurethane formulation; and
foaming the polyurethane formulation to produce the foamed polyurethane composition.

16. The method of claim 15, wherein the inorganic ionic compound is selected from the group consisting of tetrahalogens of the Group IIIA elements, and salts thereof.

17. The method of claim 16, wherein the inorganic ionic compound is selected from the group consisting of metal salts of boron, aluminum, gallium, indium, and thallium compounds.

18. The method of claim 15, wherein the inorganic tetrahalogenated ionic compound is added in the form of a solution.

19. The method of claim 15, wherein the polyurethane composition is foamable.

20. The method of claim 15, wherein the inorganic tetrahalogenated ionic compound is a salt of lithium or sodium.

21. The method of claim 15, wherein the inorganic tetrahalogenated ionic compound is of the form AMX₄, where A is a salt-forming cation or a salt-forming alkali metal; M is an element, or a compound containing an element, the element being selected from Group IIIA of the periodic table.

22. A method of imparting exotherm reduced properties to a polyurethane composition, the method comprising the step of adding to the polyurethane composition an exotherm reducing amount of an inorganic tetrahalogenated ionic compound of the form AMX₄, where A is a salt-forming cation or a salt-forming alkali metal; M is an element, or a compound containing an element, the element being selected from Group IIIA of the periodic table; and X is a halogen.

23. The method of claim 22, wherein the inorganic tetrahalogenated ionic compound is added in the form of a solution.

24. The method of claim 23, wherein the polyurethane composition is provided in the form of a foam.
